(19) United States
(12) Patent Application Publication
(10) Pub. No.: US 2024/0383782 A1
(43) Pub. Date: Nov. 21, 2024

(54) RAPID DEGRADATION AND MINERALIZATION METHOD OF PER-AND POLYHALOGENATED ORGANIC POLLUTANTS

(71) Applicant: Chongqing University, Chongqing (CN)

(72) Inventors: Chun ZHAO, Chongqing (CN); Jian ZHANG, Chongqing (CN); Shuaishuai YANG, Chongqing (CN); Wenli LI, Chongqing (CN); Mingyang ZHANG, Chongqing (CN); Chao MA, Chongqing (CN); Ziheng SONG, Chongqing (CN)

(21) Appl. No.: 18/374,390

(22) Filed: Sep. 28, 2023

(30) Foreign Application Priority Data
May 18, 2023 (CN) 2023105635541

(51) Int. Cl. C02F 1/467; C02F 1/461

(52) U.S. Cl. CPC C02F 1/4672; C02F 1/46109; C02F 2001/46133; C02F 2101/36

(57) ABSTRACT

The present disclosure a rapid degradation and mineralization method of per- and polyhalogenated organic pollutants (PHOPs), including injecting organic wastewater containing the PHOPs into a reaction chamber with a cathodic/anodic electrode system, adding an electrolyte to the organic wastewater and stirring evenly; adding a peroxide I and a peroxide II to the organic wastewater, and turning on a DC stabilized power supply and conducting a reaction, and at the end of the reaction, completing purification of the PHOPs in the wastewater. According to the present disclosure, peroxymonosulfate (PMS) and H₂O₂ are combined in electrolysis to accelerate the PMS decomposition in solution and produce more reactive oxygen species such as, ·SO₄⁻, OH, singlet oxygen (¹O₂), and a superoxide anion free radical (O₂⁻), thereby achieving cooperative of multiple oxidative and reductive reactive oxygen species, and especially increasing the generation of ·SO₄⁻ significantly.

### CROSS REFERENCE TO RELATED APPLICATION

This patent application claims the benefit and priority of Chinese Patent Application No. 202310563554.1, filed with the China National Intellectual Property Administration on May 18, 2023, the disclosure of which is incorporated by reference herein in its entirety as part of the present application.

### TECHNICAL FIELD

The present disclosure relates to the technical field of water treatment, and in particular to, a rapid degradation and mineralization method of per- and polyhalogenated organic pollutants (PHOPs).

### BACKGROUND

PHOPs refer to the organic pollutants in which all or most of hydrogen atoms in molecules are substituted by halogens, for example, perfluorooctanoic acids/perfluorosulfonic acids (PFOA/PFOS), polychlorophenol, and polybrominated diphenyl ethers. Most of these pollutants have features of persistent organic pollutants such as high toxicity, environmental persistence, bioaccumulation, semi-volatility, and long-distance migration. These substances have been widely applied in industrial and agricultural production and are thus widely present in global atmosphere, water bodies, soil sediments, and other various environments, as well as human blood and body fluids.

Currently, PHOPs are treated by physical, chemical, and biological methods. However, due to the structural stability of PHOPs, they are hardly degraded by conventional biological and chemical methods. Moreover, as halogen atoms are electron-withdrawing groups with a large number in PHOPs, PHOPs have a lower highest occupied molecular orbital and are thus hardly degraded by oxidation alone, but are easier to be degraded via dehalogenation by a reduction method on the contrary. Nevertheless, with the decrease of halogen substitutions in PHOPs, dehalogenated products are difficult to be further reduced, leading to even higher toxicity than the parent pollutant. It has been found in some studies that low-halogenated organic compounds are prone to be degraded by oxidation. Therefore, in a combined reduction-oxidation degradation system, where PHOPs are first reduced to low-halogenated products by a reduction method, and then the intermediate products are further degraded by an oxidation method, will achieve thorough/complete dehalogenation and mineralization more efficiently.

The combination of advanced oxidation and reduction technology is a kind of technology to degrade pollutants by using the in situ produced highly-active oxidative and reductive species (e.g., a hydroxyl radical (·OH), a hydrogen atom (H·)) in activation process with oxidant and/or reductant. Compared with conventional chemical methods, it showed a higher degradation efficiency for PHOPs. For example, advanced oxidation processes (AOPs) based on a strong-oxidizing and high-reactive free radical have been always concerned by researchers for a long time due to its efficient degradation effect on organic pollutants, especially, AOPs based on a sulfate radical (·SO₄⁻). Compared with a hydroxyl radical (·OH, E0=2.8 V), ·SO₄⁻ (E0=2.5-3.1 V) shows a higher oxidation reduction potential and a longer half-life period (30-40 μs, OH is 20 ns) and thus, has certain application advantages in water treatment. ·SO₄⁻ is produced via O—O bond fission caused by activating persulfates (PS), including peroxymonosulfate (PMS) and peroxydisulfate (PDS), with a catalyst or external energy. Meanwhile, reactive oxygen species such as ·OH and ¹O₂ may be also produced in the activation process to further enhance the degradation effect of pollutants. Electro-activated persulfates (PS) processes have been widely concerned due to their excellent effect, good applicability, and simple operation in environmental protection. Moreover, PS features good chemical stability; strong pH adaptability; and low manufacturing costs. However, there are still many shortcomings in the practical application of the electro-activated persulfate process (E-PS) such as, low activation ratio of free radicals, weak pollutant treatment capacity of PHOPs, and high consumption of PS dosage.

Peroxides (R′O—OR″) (including metal peroxides, hydrogen peroxide (H₂O₂), per-salts, and organic peroxides) have low manufacturing costs, green and eco-friendly and thus, are common oxidizing agents in AOPs. Compared with PS, the cost is only ¼ of the PS. Both peroxides and PS are strong oxidizing agents, but have a lower reaction ratio with pollutants and non-significant degradation effect when each of them acts in a reaction system alone. Some studies have showed that the synergy of H₂O₂ and PS has a good yield of some free radicals and certain degradation effects on pollutants, and reduces the costs of the agents used. However, the synergy of H₂O₂ and PS cannot accelerate the decomposition of PS to produce more ·SO₄ in a dual-peroxide system alone, but produces hydroperoxyl radicals (HO₂·) with a much lower oxidation reduction potential due to the reaction between H₂O₂ and the ·OH produced in the system, which affects the degradation efficiency, resulting in limited effect by coupling H₂O₂ with PS.

For example, CN108640250A has disclosed a method of removing 2,4-dichlorophenol in water by calcium peroxide-sodium persulfate dual oxidizing agents. In the method, nano-calcium peroxide is prepared by CaCl₂) and H₂O₂ in a mixed solvent of double distilled water and ammonium hydroxide via magnetic stirring firstly. Then the nano-calcium peroxide and sodium persulfate (in a certain mass ratio) are added to a certain concentration of 2,4-dichlorophenol solution, to conduct a degradation reaction. Even though the method improves the pollutant degradation rate to a certain extent, there are still problems such as low yield of free radicals, high dosage of oxidizing agents, and unsatisfactory degradation effect. Moreover, double distilled water and ammonium hydroxide are added to the system, and the mixed solvent is unstable, easy to be decomposed. Therefore, the method is not suitable for technical popularization in practical use.

### SUMMARY

With regard to the technical shortcomings described above, the objective of the present disclosure is to provide a rapid degradation and mineralization method of PHOPs. The method can solve the prior-art problems of low yield of free radicals, high dosage of oxidizing agents, and low pollutant degradation rate.

To solve the above technical problems, the present disclosure adopts the following technical solution:

A rapid degradation and mineralization method of PHOPs is provided, including injecting organic wastewater containing PHOPs into a reaction chamber having a cathodic/anodic electrode system, adding an electrolyte to the organic wastewater and stirring evenly; adding a peroxide I and a peroxide II to the organic wastewater, where the peroxide I is a persulfate, and turning on a DC stabilized power supply and conducting a reaction, to complete degradation and mineralization of the PHOPs in the organic wastewater.

Further, the peroxide II is hydrogen peroxide.

Further, the persulfate is added before the hydrogen peroxide. A persulfate is more stable than hydrogen peroxide: the addition of the persulfate first may ensure an acidic environment of a solution, and hydrogen peroxide is more stable under acidic conditions, thereby reducing the loss of hydrogen peroxide and increasing its use ratio.

Further, a mass ratio of the PHOPs, the peroxide I, and the peroxide II is 1:(10-300):(1-3); preferably, 1:(20-200): 1.

Further, the electrode system has an operating current density of 1-200 mA/cm².

Further, in the cathodic/anodic electrode system, an anodic electrode or a cathodic electrode is each selected from the group consisting of a carbon-based electrode, a metal electrode, and a metal oxide electrode.

Further, the electrolyte may be one or more selected from the group consisting of a hydrochloride, a sulfate, a nitrate, and a carbonate.

The operating principle of the present disclosure is as follows: PS can be directly activated by energy or electrons provided by an electric field under the action of an external electric field, water decomposition or other indirect ways, to produce sulfate radicals (·SO₄⁻). The ·SO₄⁻ produced by electro-activation of PS can oxidize pollutants directly, beneficial to the rupture of C—C bonds, which can also be reacted with water to produce hydroxyl radicals (·OH). ·OH is beneficial to the rupture of C—H bonds, thus further degrading pollutants. Besides, during the electro-activation of PS, singlet oxygen (¹O₂) can be produced to degrade pollutants as non-free radical degradation path. Noteworthily, after adding H₂O₂ to the E-PMS process, hydroperoxyl radical (HO₂·⁻) and superoxide anion radical (·O₂⁻) as reductive active species, can be produced at the negative alkaline diffusion layer of cathode in the system. On the one hand, such two reductive active species can damage C-halogen bonds to achieve dehalogenation. On the other hand, ·O₂⁻ will further be reacted with PMS to accelerate the PMS decomposition and ·SO₄⁻ generation, thus increasing the yield ratio of ·SO₄⁻ significantly. As can be seen, there is an excellent synergetic effect among the external electric field, H₂O₂, and PMS for the generation of both highly-active oxidative and reductive species simultaneously. Therefore, the degradation and mineralization effects of PHOPs by the electrolysis-dual peroxides process (E-PMS-H₂O₂) are much better than those of the H₂O₂, PMS, or Electrolysis process alone. It indicated that the method of the present disclosure is not just a simple numerical superposition of these treatment methods, but an efficient cooperation of each process.

Compared with the prior art, the present disclosure has the following beneficial effects:

1. The present disclosure is to degrade PHOPs pollutants mainly by adding dual-peroxides in electrolysis process for the purification of organic wastewater. In electrolysis process, PMS and H₂O₂ are added in turn to produce a coupling effect, thus accelerating the decomposition of PMS in the solution and producing more reactive oxygen species such as ·SO₄⁻, ·OH, singlet oxygen (¹O₂), and ·O₂⁻, thereby achieving cooperative degradation of PHOPs by multiple oxidative and reductive reactive oxygen species, and especially increasing the generation of ·SO₄⁻ significantly. Meanwhile, the present disclosure maximizes utilization of the oxidation agents added. Under the same conditions, compared with the E-PMS process, the E-PMS-H₂O₂ process in the present disclosure has an increased yield of ·SO₄⁻ by 17.65 times, and increased yield of ·OH by 12%. When the E-PMS-H₂O₂ process herein was used to degrade perfluorooctanoic acid (PFOA), the removal ratio is up to 99.80%. Compared with the E-PMS process and electrolysis process (E), the present disclosure had an increased PFOA removal ratio by 67.37% and by 77.73% at the same time, respectively.

2. The present disclosure has good degradation effects on PFOA under acidic, neutral, and alkaline conditions, indicating that the initial pH value has minor effects on the degradation of target pollutants in E-PMS-H₂O₂ process; therefore, the present disclosure has a wider pH applicability and increased service range of pH, and enhanced application scope.

3. The disclosed method is easy to operate and has stronger adaptability in actual natural water; and the agents used are eco-friendly. The activation efficiency of PMS can be significantly enhanced by the combination of external electric field and H₂O₂ with a relatively low electric energy consumption. Moreover, the method may achieve the efficient degradation and mineralization of PHOPs, maximize the use ratio of agents and reduce energy consumption. Therefore, the present disclosure has good application prospect for PHOPs purification in water treatment.

### BRIEF DESCRIPTION OF THE DRAWINGS

FIG. 1 shows a degradation curve of PFOA in wastewater treatment systems of Example 1 and Comparative Examples 1-2;

FIG. 2 shows a mineralization curve of PFOA in the wastewater treatment systems of Example 1 and Comparative Examples 1-2:

FIG. 3 shows a decomposition ratio of PMS in the wastewater treatment systems of Example 1 and Comparative Example 1; and

FIG. 4 is a comparison diagram showing steady-state concentrations of free radicals in the wastewater treatment systems of Example 1 and Comparative Example 1.

### DETAILED DESCRIPTION OF THE EMBODIMENTS

The specific implementation of the present disclosure will be further described below in conjunction with specific examples.

In addition, for a numerical range in the present disclosure, it should be understood that each intermediate value between an upper limit and a lower limit of the range is also specifically disclosed. Each smaller range between any stated value or intermediate value in a stated range and any other stated value or intermediate value in the stated range is also included in the present disclosure. The upper and lower limits of these smaller ranges can independently be included or excluded from the range.

Unless otherwise stated, all technical and scientific terms used herein have the same meaning as commonly understood by those of ordinary skill in the art described in the present disclosure. Although the present disclosure describes only preferred methods and materials, any methods and materials similar or equivalent to those described herein can also be used in the practice or testing of the present disclosure. All documents mentioned in this specification are incorporated by reference to disclose and describe methods and/or materials related to the documents. In case of conflict with any incorporated documents, the content of this specification shall prevail. As used herein, “including”, “having”, “containing”, and the like are all open-ended terms, which means including but not limited to.

Unless otherwise specified, the experimental methods used herein are conventional methods.

All the materials and reagents used herein are commercially available or synthesized via a known method, unless otherwise specified.

All the quantitative tests herein are set to run in triplicate, and the results are averaged.

### Example 1

Removal of PFOA in Wastewater by E-PMS-H₂O₂ Process:

Organic wastewater containing PFOA was injected into a cylindrical reactor (inner diameter: 5 cm, height: 9 cm) with anodic/cathodic electrodes system (anodic and cathodic electrodes were carbon electrodes each having a length of 5 cm, a width of 3.5 cm, and a spacing of 2 cm), and PMS was added in the solution, then the mixed materials were stirred evenly with a magnetic stirrer at a rotary speed of 800 r/min, powered on and adjusted to a preset current (current density: 28.5 mA/cm²), to start the test on the degradation of organic compounds. In the reactor, the reaction solution had a pH value of 7 and a volume of 250 mL: the PFOA had a concentration of 10 mg/L: the PMS had a concentration of 5 mmol/L, and anhydrous sodium sulfate had a concentration of 50 mmol/L. The reaction temperature was controlled at 25° C. by a thermostatic bath during the test. 12 μL of H₂O₂ (30%, a volume ratio) was added close to the cathode with a pipette during the reaction. After a period of time, sampling was conducted with an injector at 0, 0.5 min, 1 min, 2 min, 3 min, 5 min, 10 min, 15 min, 20 min, 30 min, and 40 min in a volume of 1 mL, respectively. Each 1 mL of the sample obtained above was filtered by a 0.22 μm PTFE filter membrane, separately, and added to a liquid-phase flasket to which 0.2 mL methanol was added in advance (residual free radicals in the flasket may be quenched to ensure a stable treatment effect before test), and then stored at a refrigeration condition of 3° C., and taken out when tested.

The anodic electrode or cathodic electrode may be further selected from the group consisting of a metal electrode and a metal oxide electrode. The electrolyte, anhydrous sodium sulfate, may be substituted by one or more selected from the group consisting of other sulfates, hydrochlorides, nitrates, and carbonates.

By testing, the PFOA removal ratio was up to 99.80% and the mineralization ratio was up to 86.5%.

### Example 2

The treatment method in Example 2 was basically the same as that in Example 1. Example 2 differs from Example 1 in that PMS had a concentration of 3 mmol/L and the amount of H₂O₂ added was 12 μL in the reaction solution.

The change of PFOA concentration in the wastewater to be treated was measured and a PFOA removal ratio was calculated to be 99.67%.

### Example 3

The treatment method in Example 3 was the same as that in Example 1. Example 3 differs from Example 1 in that PMS had a concentration of 5 mmol/L and the amount of H₂O₂ added was 24 μL in the reaction solution.

The change of PFOA concentration in the wastewater to be treated was measured and a PFOA removal ratio was calculated to be 99.74%.

### Example 4

The treatment method in Example 4 was basically the same as that in Example 1. Example 4 differs from Example 1 in that the reaction solution had a pH value of 6.

The change of PFOA concentration in the wastewater to be treated was measured and a PFOA removal ratio was calculated to be 99.73%.

### Example 5

The treatment method in Example 5 was basically the same as that in Example 1. Example 5 differs from Example 1 in that the reaction solution had a pH value of 9.

The change of PFOA concentration in the wastewater to be treated was measured and a PFOA removal ratio was calculated to be 99.82%.

As can be seen from the comparison among Examples 1, 4, and 5, the degradation effects on PFOA were stabilized above 99% under acidic, neutral, and alkaline conditions, indicating a good treatment effect. Thus, the initial pH value has minor effects on the degradation of the system on target pollutants; therefore, the present disclosure has a wider pH applicability and increased service range of pH, and enhanced application scope.

### Comparative Example 1

### Removal of PFOA in Wastewater by E-PMS Process:

Organic wastewater containing PFOA was injected into a cylindrical reactor (inner diameter: 5 cm, height: 9 cm) with a cathodic/anodic electrode system (cathodic and anodic electrodes were carbon electrodes each having a length of 5 cm, a width of 3.5 cm, and a spacing of 2 cm), and PMS solution was added in the solution, and the mixed materials were stirred evenly with a magnetic stirrer at a rotary speed of 800 r/min, powered on and adjusted to a preset current (current density: 28.5 mA/cm²), to start the test on the degradation of organic compounds. In the reactor, the reaction solution had a volume of 250 mL: the PFOA had a concentration of 10 mg/L; the PMS had a concentration of 5 mmol/L, and anhydrous sodium sulfate had a concentration of 50 mmol/L. The reaction temperature was controlled at 25° C. by a thermostatic bath during the test. After a period of time, sampling was conducted with an injector at 0, 0.5 min, 1 min, 2 min, 3 min, 5 min, 10 min, 15 min, 20 min, 30 min, and 40 min in a volume of 1 mL, respectively. Each 1 mL of the sample obtained above was filtered by a 0.22 μm PTFE filter membrane, separately, and added to a liquid-phase flasket to which 0.2 mL methanol was added in advance, and then stored at a refrigeration condition of 3° C., and taken out when tested.

### Comparative Example 2

### Removal of PFOA in Wastewater by an Electrolysis System:

Organic wastewater containing PFOA was injected into a cylindrical reactor (inner diameter: 5 cm, height: 9 cm) with a cathodic/anodic electrode system (cathodic and anodic electrodes were carbon electrodes each having a length of 5 cm, a width of 3.5 cm, and a spacing of 2 cm), and stirred evenly with a magnetic stirrer at a rotary speed of 800 r/min, powered on and adjusted to a preset current (current density: 28.5 mA/cm²), to start the test on the degradation of organic compounds. In the reactor, the reaction solution had a volume of 250 mL; PFOA had a concentration of 10 mg/L; and anhydrous sodium sulfate had a concentration of 50 mmol/L. The reaction temperature was controlled at 25° C. by a thermostatic bath during the test. After a period of time, sampling was conducted with an injector at 0, 0.5 min, 1 min, 2 min, 3 min, 5 min, 10 min, 15 min, 20 min, 30 min, and 40 min in a volume of 1 mL, respectively. Each 1 mL of the sample obtained above was filtered by a 0.22 μm PTFE filter membrane, separately, and added to a liquid-phase flasket to which 0.2 mL methanol was added in advance, and then stored at a refrigeration condition of 3° C., and taken out when tested.

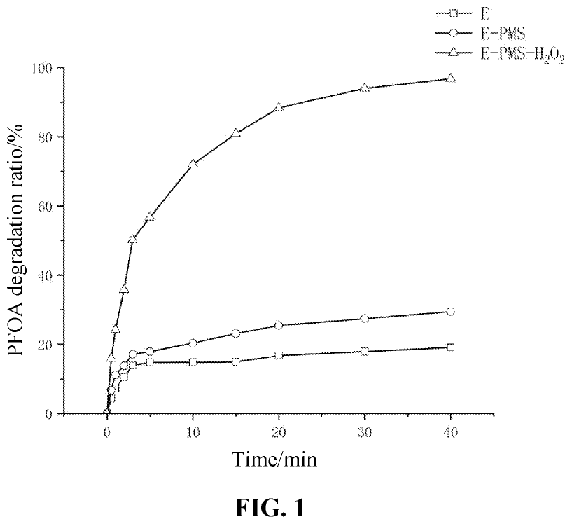

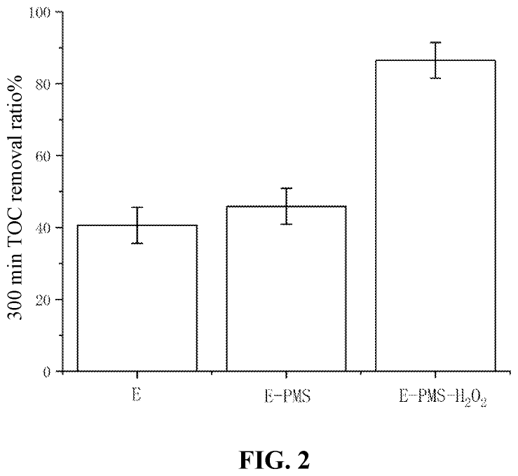

FIG. 1 shows a PFOA degradation curve of wastewater treatment systems in Example land Comparative Examples 1-2: FIG. 2 shows a PFOA mineralization curve of the wastewater treatment systems in Example 1 and Comparative Examples 1-2. As can be seen from FIGS. 1 and 2, the E-PMS-H₂O₂ process (electrolysis-dual peroxides system) in Example 1 had a removal ratio of 99.80% and a mineralization ratio of 86.5% to PFOA in the target solution. The E-PMS process in Comparative Example 1 had a removal ratio of 29.43% and a mineralization ratio of 45.9% to PFOA in the target solution. The separate electrolysis process had a removal ratio of 19.07% and a mineralization ratio of 40.6% to PFOA in the target solution. Thus as can be seen, under the same conditions, compared with the E-PMS process, the E-PMS-H₂O₂ process herein had an increased PFOA removal ratio by 67.37% and an increased mineralization ratio by 40.6%; and compared with the E process, the E-PMS-H₂O₂ process herein had an increased PFOA removal ratio by 77.73% and an increased mineralization ratio by 45.9%. As can be seen, the wastewater treatment effect of the E-PMS-H₂O₂ process herein is obviously better than that of the E-PMS process and the E process. Moreover, there exists a coupling effect among the electric field/PMS/H₂O₂ in the E-PMS-H₂O₂ process, which greatly enhances interaction and use ratio of the agents, improves the production efficiency of reactive oxygen species, thereby increasing the PFOA removal ratio and mineralization ratio in wastewater, maximizing the use ratio and degradation efficiency of the agent added. Compared with the E-PMS process and the E process, the present disclosure achieves unexpected technical effects.

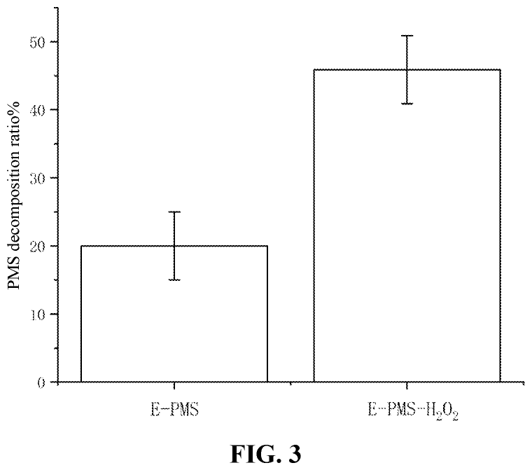

FIG. 3 shows a decomposition ratio of PMS in the wastewater treatment systems of Example 1 and Comparative Example 1: as can be seen from FIG. 3, the decomposition ratio of PMS in the target solution of the E-PMS-H₂O₂ (electrolysis-dual peroxides process) in Example 1 is up to 45.60%, while the decomposition ratio of PMS in the target solution of the E-PMS treatment process in Comparative Example 1 is up to 20.21%. As can be seen from the comparison between Example 1 and Comparative Example 1, under the same conditions, the E-PMS-H₂O₂ process herein has an increased PMS decomposition ratio by 25.39%, compared with the E-PMS process. Therefore, there exists a coupling effect among the electric field/PMS/H₂O₂ in the wastewater treatment system herein, which greatly enhances interaction and use ratio of the agents. Hence, the PMS decomposition ratio herein is much greater than that in the E-PMS process, thus maximizing the use ratio of the agents and enhancing the wastewater treatment effect.

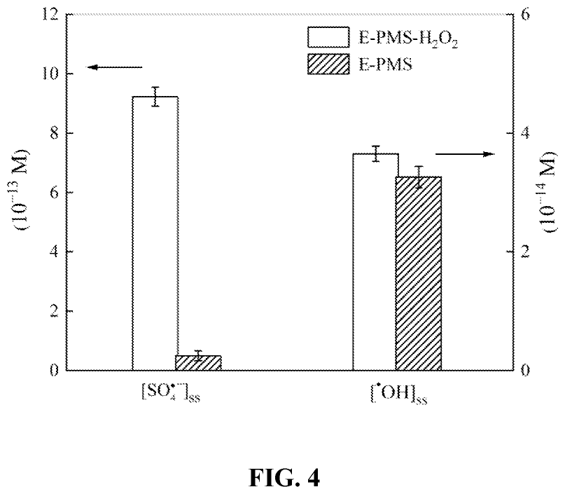

FIG. 4 is a comparison diagram showing steady-state concentrations of free radicals in the wastewater treatment systems of Example 1 and Comparative Example 1. As can be seen from FIG. 4, compared with the E-PMS process in Comparative Example 1, the SO₄-yield of the E-PMS-H₂O₂ process herein is improved by 17.65 times, and the ·OH yield is improved by 12%. As can be seen, the production efficiency of the reactive oxygen species is enhanced by the coupling effect among electric/PMS/H₂O₂. Moreover, under the same conditions, the more the reactive oxygen species produced there are, the stronger the removal capacity of PFOA in wastewater is. The present disclosure may produce more reactive oxygen species at the same amount of PMS added, which is of great importance to the reduction of agents added and cost saving.

In the present disclosure, electric field/persulfate/hydrogen peroxide serves as a wastewater treatment system inventively: the coupling effect among the three is utilized to enhance the interaction and use ratio of the agents, improve the generation ratio of reactive oxygen species, and maximize the use ratio and degradation efficiency of the agents added. Therefore, the present disclosure greatly improves the removal ratio of PFOA and other halogenated organic pollutants in the wastewater, and solves the problems in the existing PHOPs degradation methods such as low yield of free radicals, high dosage of oxidizing agents, and weak treatment capacity.

It should be noted that the above examples are only intended to explain, rather than to limit the technical solutions of the present disclosure. Those of ordinary skill in the art should understand that modifications or equivalent substitutions may be made to the technical solutions of the present disclosure without departing from the spirit and scope of the technical solutions of the present disclosure, and such modifications or equivalent substitutions should be included within the scope of the claims of the present disclosure.

What is claimed is:

1. A rapid degradation and mineralization method of per- and polyhalogenated organic pollutants (PHOPs), comprising injecting organic wastewater comprising the PHOPs into a reaction chamber having a cathodic/anodic electrode system, adding an electrolyte to the organic wastewater and stirring evenly; adding a peroxide I and a peroxide II to the organic wastewater, wherein the peroxide I is a persulfate, and turning on a direct current (DC) stabilized power supply and conducting a reaction, to complete degradation and mineralization of the PHOPs in the organic wastewater.

2. The rapid degradation and mineralization method of PHOPs according to claim 1, wherein the peroxide II is hydrogen peroxide.

3. The rapid degradation and mineralization method of PHOPs according to claim 2, wherein the persulfate is added before the hydrogen peroxide.

4. The rapid degradation and mineralization method of PHOPs according to claim 1, wherein a mass ratio of the PHOPs, the peroxide I, and the peroxide II is 1:(10-300):(1-3).

5. The rapid degradation and mineralization method of PHOPs according to claim 1, wherein the electrode system has an operating current density of 1-200 mA/cm².

6. The rapid degradation and mineralization method of PHOPs according to claim 1, wherein in the cathodic/anodic electrode system, an anodic electrode or a cathodic electrode is each selected from the group consisting of a carbon-based electrode, a metal electrode, and a metal oxide electrode.

7. The rapid degradation and mineralization method of PHOPs according to claim 1, wherein the electrolyte is one or more selected from the group consisting of a hydrochloride, a sulfate, a nitrate, and a carbonate.

8. The rapid degradation and mineralization method of PHOPs according to claim 4, wherein the mass ratio of the PHOPs, the peroxide I, and the peroxide II is 1:(20-200): 1.
